(19) United States
(12) Patent Application Publication
(10) Pub. No.: US 2012/0311032 A1
(43) Pub. Date: Dec. 6, 2012

(54) EMOTION-BASED USER IDENTIFICATION FOR ONLINE EXPERIENCES

(75) Inventors: Brian Scott Murphy, Seattle, WA (US); Stephen G. Latta, Seattle, WA (US); Darren Alexander Bennett, Seattle, WA (US); Pedro Perez, Kirkland, WA (US); Shawn C. Wright, Sammamish, WA (US); Relja Markovic, Seattle, WA (US); Ryan Lucas Hastings, Seattle, WA (US); Kevin Geisner, Mercer Island, WA (US)

(73) Assignee: MICROSOFT CORPORATION, Redmond, WA (US)

(21) Appl. No.: 13/151,903

(22) Filed: Jun. 2, 2011

(51) Int. Cl. G06F 15/16

(52) U.S. Cl. 709/204

(57) ABSTRACT

Emotional response data of a particular user, when the particular user is interacting with each of multiple other users, is collected. Using the emotional response data, an emotion of the particular user when interacting with each of multiple other users is determined. Based on the determined emotions, one or more of the multiple other users are identified to share an online experience with the particular user.

### BACKGROUND

Online gaming services allow users to play games by themselves, or to play games together with one or more of their friends. While playing games together with friends is very enjoyable for many users, it is not without its problems. One such problem is that it can be difficult for a user to select which other users he or should would enjoy playing a game with. This selection process can be frustrating for users, reducing the user friendliness of the games.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, emotions of a particular user are determined when the particular user is interacting with each of multiple other users. Based on the determined emotions, one or more of the multiple other users are identified to share an online experience with the particular user.

In accordance with one or more aspects, indications of emotions of a particular user when interacting with each of multiple other users is received. Based on the received indications of emotions, one or more of the other users to share an online experience with the user are identified.

### BRIEF DESCRIPTION OF THE DRAWINGS

The same numbers are used throughout the drawings to reference like features.

FIG. 1 illustrates an example system implementing the emotion-based user identification for online experiences in accordance with one or more embodiments.

FIG. 2 illustrates an example computing device and display in additional detail in accordance with one or more embodiments.

FIG. 3 illustrates an example user interface that can be displayed to a user to allow the user to select whether his or her emotions will be detected in accordance with one or more embodiments.

FIG. 4 illustrates an example emotion-based user identification system in accordance with one or more embodiments.

FIG. 5 illustrates another example emotion-based user identification system in accordance with one or more embodiments.

FIG. 6 is a flowchart illustrating an example process for implementing emotion-based user identification for online experiences in accordance with one or more embodiments.

FIG. 7 is a flowchart illustrating another example process for implementing emotion-based user identification for online experiences in accordance with one or more embodiments.

FIG. 8 illustrates an example computing device that can be configured to implement the emotion-based user identification for online experiences in accordance with one or more embodiments.

### DETAILED DESCRIPTION

Emotion-based user identification for online experiences is discussed herein. Emotional responses of a user are detected based on that user's interaction with other users, such as while playing online games with the other users, communicating with the other users, and so forth. These emotional responses can take various forms, such as facial expressions, audible expressions, language in messages, and so forth. This collected emotional response data is used as a factor in identifying other users to share an online experience with (e.g., play an online game together, watch an online movie together, etc.), allowing other users to be selected for a more enjoyable online experience for the user (e.g., allowing other users that the user is frequently happy when interacting with to be selected). Various other factors can also be considered when identifying other users to share an online experience with, such as geographic distance between users, a social distance between the users, and so forth.

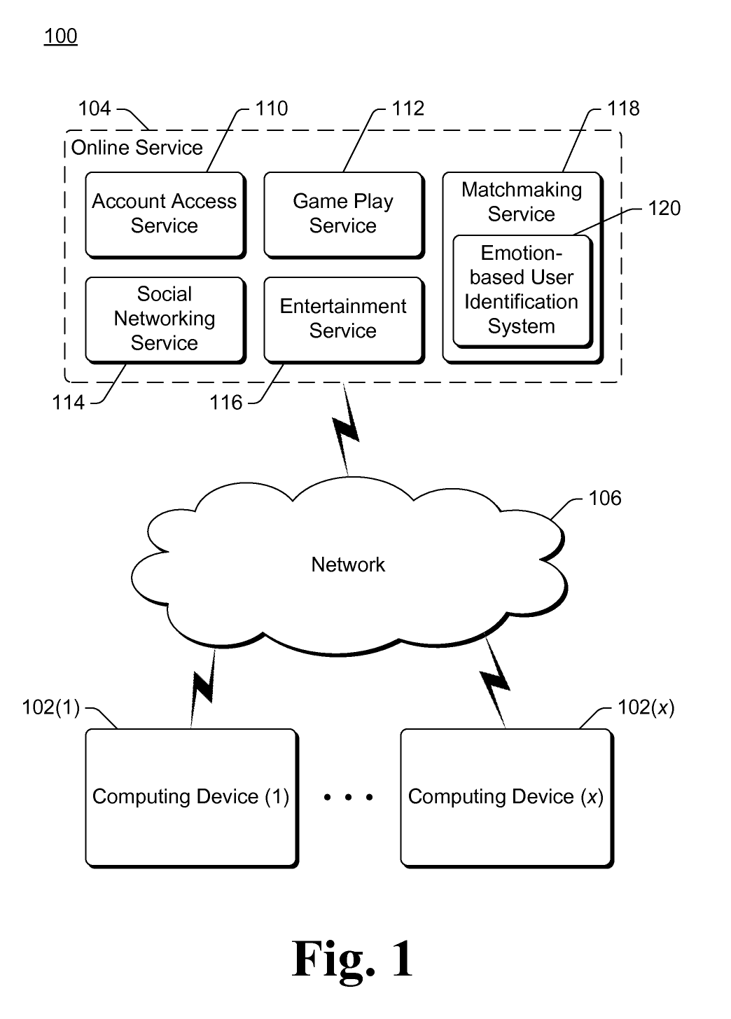

FIG. 1 illustrates an example system 100 implementing the emotion-based user identification for online experiences in accordance with one or more embodiments. System 100 includes multiple (x) computing devices 102 and an online service 104 that can communicate with one another via a network 106. Network 106 can be a variety of different networks, including the Internet, a local area network (LAN), a wide area network (WAN), a personal area network (PAN), a phone network, an intranet, other public and/or proprietary networks, combinations thereof, and so forth.

Each computing device 102 can be a variety of different types of computing devices. Different ones of computing devices 102 can be the same or different types of devices. For example, computing device 102 can be a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth.

Online service 104 provides one or more of various online services to users of computing devices 102, allowing users to share online experiences (e.g., play online games together, watch movies together, etc.). Service 104 is referred to as being an online service due to computing devices 102 accessing service 104 (and/or other computing devices 102) via network 106. Online service 104 includes an account access service 110, a game play service 112, a social networking service 114, an entertainment service 116, and a matchmaking service 118, each of which can communicate with one another. Services 110-118 can communicate with one another within online service 104 and/or via computing devices 102. Although illustrated as including multiple services, it should be noted that online service 104 need not include all of the services 110-118 illustrated in FIG. 1. For example, online service 104 may not include social networking service 114 and/or entertainment service 118. Additionally, it should be noted that online service 104 can include additional services, such as email or text messaging services, telephone services, video conferencing services, and so forth.

Account access service 110 provides various functionality supporting user accounts of online service 104. Different users and/or computing devices 102 typically have different accounts with online service 104, and can log into their accounts via account access service 110. A user or computing device 102 logs into an account providing credential information, such as an id (e.g., user name, email address, etc.) and password, a digital certificate or other data from a smartcard, and so forth. Account access service 110 verifies or authenticates the credential information, allowing a user or computing device 102 to access the account if the credential information is verified or authenticated, and prohibiting the user or computing device 102 from accessing the account if the credential information is not verified or is not authenticated. Once a user's credential information is authenticated, the user can use the other services provided by online gamine service 104. Account access service 110 can also provide various additional account management functionality, such as permitting changes to the credential information, establishing new accounts, removing accounts, and so forth.

Game play service 112 provides various functionality supporting playing of one or more different games by users of computing devices 102. Different game titles can be supported by game play service 112 (e.g., one or more different sports game titles, one or more different strategy game titles, one or more different adventure game titles, one or more different simulation game titles, and so forth). A game title refers to a particular set of instructions that implement a game when executed (e.g., a set of instructions for a tennis game from a particular vendor, a set of instructions for a particular racing game from a particular vendor, etc). A particular running of a game title is also referred to as a game. Multiple games of the same game title can be played concurrently by different users, each game being a separate running of the game title. Games can be run and played as multi-player games in which multiple users of one or more computing devices 102 are playing the same game and each user is controlling one or more characters in the game.

Social networking service 114 provides various functionality supporting social networking to users of computing devices 102. Social networking allows users to share information with other users, such as comments, pictures, videos, links to Web sites, and so forth. This information can be shared by being posted to a wall or other location, being included in an album or library, being included in messages or other communications, and so forth.

Entertainment service 116 provides various functionality supporting providing entertainment services to users of computing devices 102. Various types of entertainment functionality can be provided by entertainment service 116, such as audio playback functionality, audio/video playback functionality, and so forth. For example, entertainment service 116 can include music player functionality allowing multiple users to listen to the same music titles (e.g., songs) and talk to (or otherwise communicate with) one another while listening to those music titles. By way of another example, entertainment service 116 can include audio/video (e.g., movies or television shows) player functionality allowing multiple users to watch the same titles (e.g., television shows, movies) and talk to (or otherwise communicate with) one another while watching those titles.

Online service 104 allows multiple users to share an online experience. An online experience refers to playing back or using content, a title, a game title, etc. from an online service (e.g., online service 104). A shared online experience or users sharing an online experience refers to two or more users playing back or using the same content, title, or game title concurrently via an online service (e.g., online service 104). The two or more users are typically, but need not be, using different computing devices 102 during sharing of the online experience. For example, multiple users can share an online experience by playing in a multi-player video game using game play service 112. By way of another example, multiple users can share an online experience by watching (and talking to one another while watching) the same movie using entertainment service 116.

Matchmaking service 118 provides various functionality facilitating the selecting of other users with which a user of computing device 102 can share an online experience. Matchmaking service 118 can identify other users with which a particular user can play share an online experience in a variety of different manners using a variety of different factors, as discussed in more detail below. Matchmaking service 118 can identify other users based on user accounts that account access service 110 is aware of, based on users logged into their accounts at a particular time (e.g., as indicated by account access service 110), based on accounts from other services, and so forth. Matchmaking service 118 can identify other users with which a user of computing device 102 can share an online experience across the same and/or different types of computing devices 102 (e.g., one or more users of a desktop computer and one or more users of a game console, one or more users of a phone and one or more users of a game console, etc.). Similarly, matchmaking service 118 can identify other users with which a user of computing device 102 can share an online experience across the same and/or different services (e.g., one or more users of game play service 112 and one or more users of entertainment service 116).

Matchmaking service 118 includes an emotion-based user identification system 120. Emotion-based user identification system 120 determines emotions of a user when he or she interacts with other users. These determined emotions are used by matchmaking service 118 as a factor in identifying other users for a particular user to share an online experience with as discussed in more detail below.

Each of services 110-118 can be implemented using one or more computing devices. Typically these computing devices are server computers, but any of a variety of different types of computing devices can alternatively be used (e.g., any of the types of devices discussed above with reference to computing device 102). Each of services 110-118 can be implemented using different computing devices, or alternatively at least part of one or more of services 110-118 can be implemented using the same computing device.

Each of services 110-118 is typically run by executing one or more programs. The programs that are executed to run a service 110-118 can be run on computing devices 102 and/or devices implementing online service 104. In one or more embodiments, services 110-118 are programs executed on computing devices 102 and the service 110-118 manages communication between different computing devices 102. In other embodiments, services 110-118 are programs executed on computing devices 102 and the service 110-118 facilitates establishing communication between different computing devices 102. After communication between two computing devices 102 is established, communication can be made between those two computing devices 102 without involving the service 110-118. In other embodiments, online service 104 can execute one or more programs for the service 110-118, receiving inputs from users of computing devices 102 and returning data indicating outputs to be generated for display or other presentation to the users of computing devices 102.

Additionally, although services 110-118 are illustrated as separate services, alternatively one or more of these services can be implemented as a single service. For example, game play service 112 and matchmaking service 118 can be implemented as a single service. Furthermore, the functionality of one or more of services 110-118 can be separated into multiple services. In addition, the functionality of online service 104 can be separated into multiple services. For example, online service 104 may include account access service 110 and game play service 112, a different service can include social network service 114, a different service can include entertainment service 116, and a different service can include matchmaking service 118.

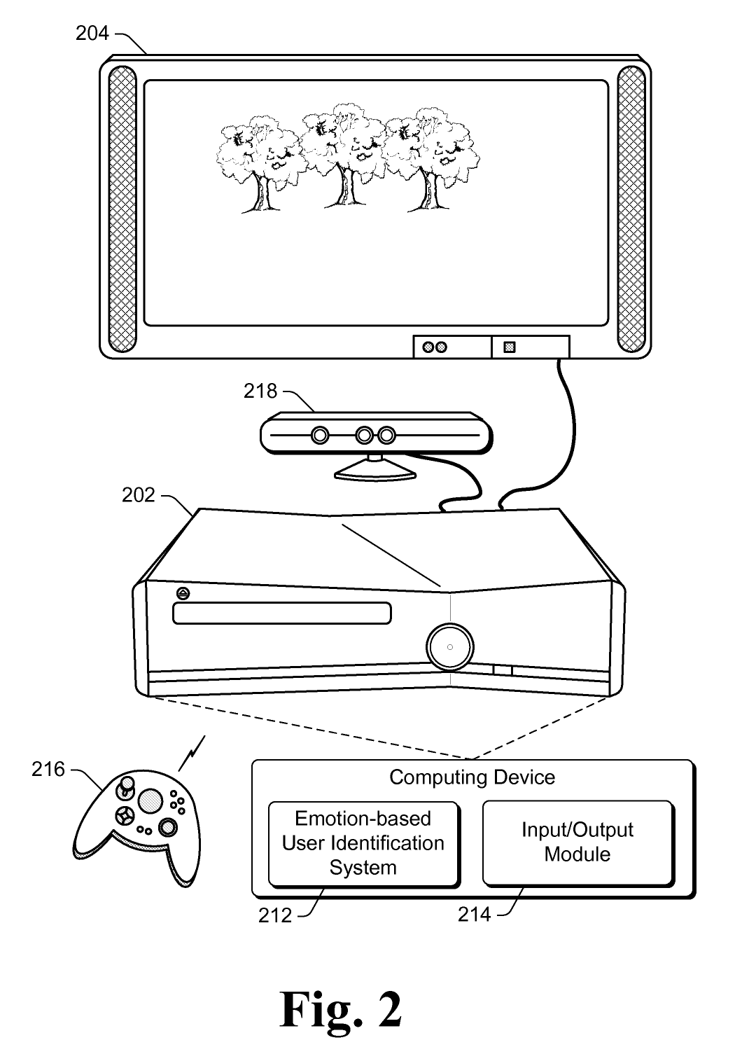

FIG. 2 illustrates an example computing device and display in additional detail in accordance with one or more embodiments. FIG. 2 illustrates a computing device 202, which can be a computing device 102 of FIG. 1, coupled to a display device 204 (e.g., a television). Computing device 202 and display device 204 can communicate via a wired and/or wireless connection. Computing device 202 includes an emotion-based user identification system 212 and an input/output (I/O) module 214. Emotion-based user identification system 212 is analogous to emotion-based user identification system 120 of FIG. 1, although the emotion-based user identification system is illustrated as implemented in computing device 202 rather than in an online service.

Input/output module 214 provides functionality relating to recognition of inputs and/or provision of (e.g., display or other presentation of) outputs by computing device 202. For example, input/output module 214 can be configured to receive inputs from a keyboard or mouse, to identify gestures and cause operations to be performed that correspond to the gestures, and so forth. The inputs can be detected by input/output module 214 in a variety of different ways.

Input/output module 214 can be configured to receive one or more inputs via touch interaction with a hardware device, such as a controller 216 as illustrated. Touch interaction may involve pressing a button, moving a joystick, movement across a track pad, use of a touch screen of display device 204 or controller 216 (e.g., detection of a finger of a user's hand or a stylus), other physical inputs recognized by a motion detection component (e.g., shaking a device, rotating a device, etc.), and so forth. Recognition of the touch inputs can be leveraged by input/output module 214 to interact with a user interface output by computing device 202, such as to interact with a game, change one or more settings of computing device 202, and so forth. A variety of other hardware devices are also contemplated that involve touch interaction with the device. Examples of such hardware devices include a cursor control device (e.g., a mouse), a remote control (e.g., a television remote control), a mobile communication device (e.g., a wireless phone configured to control one or more operations of computing device 202), and other devices that involve touch on the part of a user or object.

Input/output module 214 can also be configured to receive one or more inputs in other manners that do not involve touch or physical contact. For example, input/output module 214 can be configured to receive audio inputs through use of a microphone (e.g., included as part of or coupled to computing device 202). By way of another example, input/output module 214 can be configured to recognize gestures, presented objects, images, and so forth through the use of a camera 218. The images can also be leveraged by computing device 202 to provide a variety of other functionality, such as techniques to identify particular users (e.g., through facial recognition), objects, and so on.

Computing device 202 can also leverage camera 218 to perform skeletal mapping along with feature extraction of particular points of a human body (e.g., 48 skeletal points) to track one or more users (e.g., four users simultaneously) to perform motion analysis. For instance, camera 218 can capture images that are analyzed by input/output module 214 or a game running on computing device 202 to recognize one or more motions made by a user, including what body part is used to make the motion as well as which user made the motion. The motions can be identified as gestures by input/output module 214 or the running game to initiate a corresponding operation.

The emotion-based user identification system (e.g., system 212 of FIG. 2 or system 120 of FIG. 1) determines emotions of a user. In one or more embodiments, the determining of a user's emotions is performed only after receiving user consent to do so. This user consent can be an opt-in consent, where the user takes an affirmative action to request that the emotion determination be performed before any of that user's emotions are determined. Alternatively, this user consent can be an opt-out consent, where the user takes an affirmative action to request that the determination of that user's emotions not be performed. If the user does not choose to opt out of this determining, then it is an implied consent by the user to determine that user's emotional responses. Similarly, data mining, location detection, and other information can be obtained and used by the emotion-based user identification system discussed herein only after receiving user consent to do so.

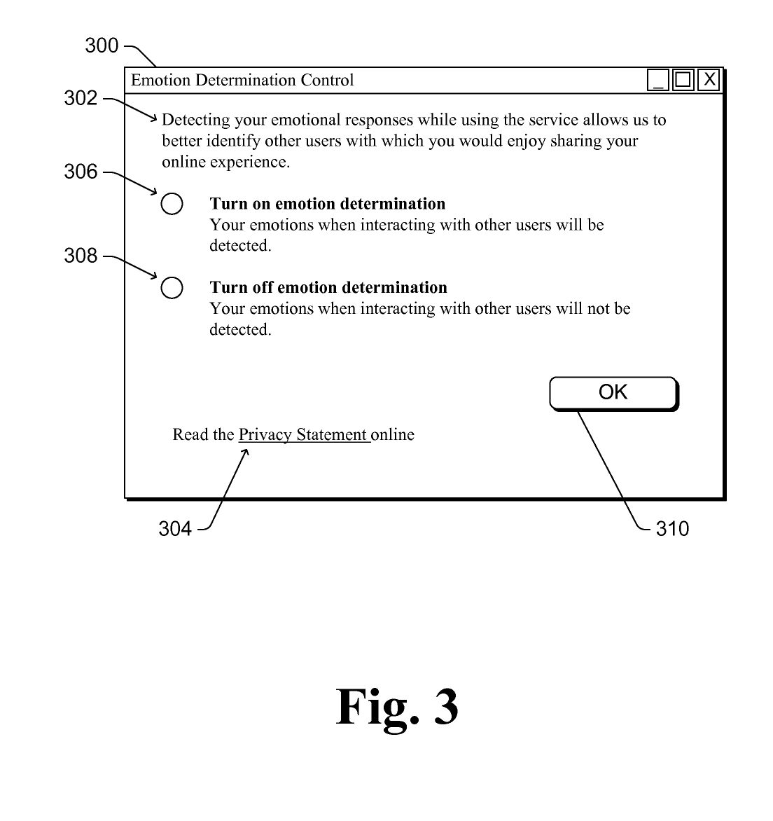

FIG. 3 illustrates an example user interface that can be displayed to a user to allow the user to select whether his or her emotions will be determined in accordance with one or more embodiments. An emotion determination control window 300 is displayed including a description 302 explaining to the user why his or her emotions are being determined or detected. A link 304 to a privacy statement is also displayed. If the user selects link 304, a privacy statement (e.g. of online service 104 of FIG. 1) is displayed explaining to the user how the user's information is kept confidential.

Additionally, the user is able to select a radio button 306 to opt-in to the emotion determination, or a radio button 308 to opt-out of the emotion determination. Once a radio button 306 or 308 is selected, the user can select an “OK” button 310 to have the selection saved. It should be noted that radio buttons and an “OK” button are only examples of user interfaces that can be presented to a user to opt-in or opt-out of the emotional response determination, and that a variety of other conventional user interface techniques can alternatively be used. The emotion-based user identification system then proceeds to collect emotional response data and determine the user's emotions, or not collect emotional response data and not determine the user's emotions, in accordance with the user's selection.

Although discussed with reference to emotion determination, additional control windows analogous to emotion determination control window 300 can be displayed allowing a user to turn on and turn off other data mining, location detection, and so forth used by the emotion-based user identification system discussed herein. Alternatively, additional information identifying the data mining, location detection, and so forth used by the emotion-based user identification system discussed herein can be displayed in emotion determination control window 300, allowing the user to turn on and turn off the other data mining, location detection, and so forth used by the emotion-based user identification system discussed herein.

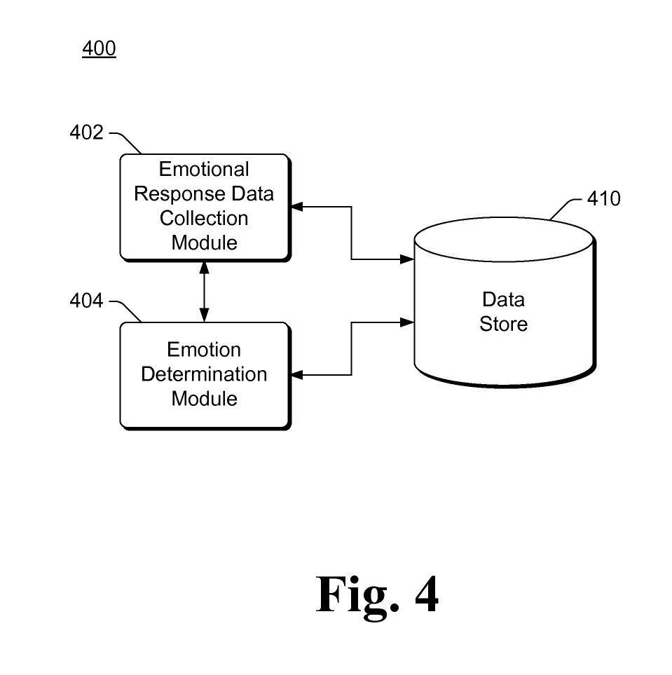

FIG. 4 illustrates an example emotion-based user identification system 400 in accordance with one or more embodiments. Emotion-based user identification system 400 can be, for example, an emotion-based user identification system 120 of FIG. 1 or an emotion-based user identification system 212 of FIG. 2. Emotion-based user identification system 400 can be implemented at least in part in an online service (e.g., online service 104 of FIG. 1) and/or at least in part in a computing device (e.g., a computing device 102 of FIG. 1 or computing device 202 of FIG. 2). System 400 includes an emotional response data collection module 402, an emotion determination module 404, and a data store 410.

Generally, emotional response data collection module 402 collects various data regarding emotional responses of users of system 400. Emotion determination module 404 analyzes the collected data regarding emotional responses of a user of system 400 and determines, for each of one or more other users of system 400, an emotion of the user when the user is interacting with the one or more other users.

Emotional response data collection module 402 collects data for a user of system 400 with respect to each of one or more other users. The collected data can be provided to emotion determination module 404 as the data is collected, or alternatively maintained in data store 410 and obtained by emotion determination module 404 at a later time. A user can have a different emotional response during online experiences shared with different users, even if the content or title being played back or used is the same with the different users. For example, a user may laugh more when playing a game with one user than with another user. Accordingly, the data collected by module 402 is collected for a user of system 400 with respect to each of one or more other users, and a separate record is maintained (e.g., in data store 410) for the data collected for each user with respect to each other user.

A user can share different types of experiences with other users. A type of experience can refer to a particular content, title, or game title being used or played back (e.g., a particular tennis game title from a particular vendor, a particular movie title, etc.). Alternatively, a type of experience can refer to a particular classification or genre of content, title, or game title being used or played back (e.g., sports games, comedy movies or television shows, etc.).

Additionally, a user can have a different emotional response during different types of shared online (or other) experiences with the same user. For example, the emotional response during an online experience of playing a particular game can be different than the emotional response during an online experience playing a different game with the same user. Accordingly, in one or more embodiments emotional response data collection module 402 generates a record including indications of emotional responses of a particular user, an indication of another user that particular user is interacting with when the emotional responses occurred, and an indication of the type of experience when the emotional responses occurred.

In one or more embodiments, emotional response data collection module 402 collects data indicating emotional responses of a user during that user's interaction with another user during a shared online experience with that other user. Emotional response data can be collected for multiple online experiences with that other user. For the collected data, module 402 maintains a record of the other user that was part of the online experience as well as the type of experience. The data indicating emotional responses can take various forms, such as detected facial features, detected sounds, and so forth. For example, a variety of different conventional (and/or proprietary) facial feature detection techniques can be used to detect different facial expressions of the user, such as detecting when the user is smiling, frowning, and so forth. Module 402 can collect data indicating these detected facial expressions, as well as data indicating when the facial expressions were detected (and optionally a duration of the facial expressions, such as how long the user was smiling). By way of another example, a variety of different conventional (and/or proprietary) audio feature detection techniques can be used to detect different audible expressions of the user, such as detecting when the user is laughing, crying, and so forth. Module 402 can collect data indicating these detected audible expressions, as well as data indicating when the audible expressions were detected (and optionally a duration of the audible expressions, such as how long the user was laughing).

In one or more embodiments emotional response data collection module 402 collects data indicating emotional responses of a user during that user's interaction with another user during an in-person experience with that other user. Emotional response data can be collected for multiple in-person experiences with that other user. An in-person experience refers to two or more users playing back or using the same content or title in each other's presence, similar to an online experience but the users need not be interacting using an online service (e.g., online service 104 of FIG. 1). For example, the users can be sitting in the same room playing a game or watching a movie, and are not logged into the online service. For the collected data, module 402 maintains a record of the other user that was part of the in-person experience as well as the type of experience. The data indicating emotional responses can take various forms, such as detected facial features, detected sounds, and so forth, analogous to the discussion above regarding module 402 collecting data indicating emotional responses of a user during an online experience. Additionally, the data indicating emotional responses can be detected physical interactions between two or more users. For example, a variety of different conventional (and/or proprietary) gesture or motion detection techniques can be used to detect different physical interactions between two or more users, such as detecting whether the users are giving one another hi-fives, giving one another hugs, and so forth.

In one or more embodiments, emotional response data collection module 402 collects data indicating emotional responses of a user from interactions with other users that are messages or other communications (e.g., text messages, email messages, etc.). These communications can be sent, for example, via social networking service 114 of FIG. 1. The language of these communications can be analyzed to identify emotional responses. For example, a variety of different conventional (and/or proprietary) data mining techniques can be used to detect different feelings (e.g., happiness, sadness, etc.) expressed in communications. Module 402 can collect data indicating these detected feelings as emotional responses of the user when communicating with each of the other users.

Emotion determination module 404 analyzes the emotional response data collected by emotional response data collection module 402 and determines an emotion of a user of system 400. This analysis can be performed at different times, such as at regular or irregular intervals during a shared experience including the users, at the end of an interaction between users (e.g., when a game or level of a game the two users are playing ends), and so forth. Each emotion of the user determined by module 404 is an emotion of the user for a particular one other user, and also optionally for a particular type of experience with that particular one other user. Thus, multiple emotions for a user are determined, each determined emotion corresponding to a particular other user and optionally to a particular type of experience.

Emotion determination module 404 can analyze the emotional response data collected by emotional response data collection module 402 using a variety of different conventional and/or proprietary techniques to determine an emotion based on the collected data. The determined emotion can be represented in various forms. For example, the determined emotion can be represented as a Boolean value (e.g., indicating the emotion is happy or not happy, indicating the emotion is sad or not sad, etc.). By way of another example, the determined emotion can be represented as a particular value from a set of possible values (e.g., possible values of very sad, sad, happy, very happy, etc.). By way of yet another example, the determined emotion can be represented as a numeric value indicating the user's emotional response (e.g., ranging from 1-100, with 1 indicating very unhappy and 100 indicating very happy).

Various different rules, criteria, and/or algorithms can be used by emotion determination module 404 to determine the emotion. For example, a check can be made as to whether the user was detected as smiling and/or laughing for at least a threshold amount of time, and a Boolean value set to indicate happy (e.g., a value of 1 or True) if the user was detected as smiling and/or laughing for at least the threshold amount of time, and set to indicate not happy (e.g., a value of 0 or False) if the user was not detected as smiling and/or laughing for at least the threshold amount of time. By way of another example, a percentage of “happy” communications between two users can be determined by dividing a number of communications (e.g., text messages and email messages) between two users that are identified as expressing happy feelings by a total number of communications between the two users, and the percentage multiplied by 100 to determine a numeric value ranging from 1-100 to indicate what percentage of communications between the two users express happy feelings.

Emotion determination module 404 can optionally store the determined emotions of a user in data store 410. Module 404 can also optionally update these stored emotions over time as additional emotional response data is collected by module 402 (e.g., due to further interaction between the users).

Thus, for each user of system 400, a set of emotions can be determined. This set of determined emotions includes a determined emotion for each other user of multiple other users of system 400, and optionally a determined emotion for each type of experience with each other user of the multiple other users of system 400. This set of emotions for a particular user can be used to identify one or more of the other users for the particular user to share an online experience with. For example, when the particular user is typically laughing or smiling while sharing an online experience with a particular other user, that particular other user can be identified as a user for the particular user to share an online experience with.

Emotion determination module 404 provides an indication of the determined emotions to another component or module to be used at least in part for identification of other users to share in an online experience with a user. The indication of the determined emotions can be provided to a user identification module that identifies users for online experiences. The indication of the determined emotions can alternatively be provided to a score generation module that generates a score based at least in part on the determined emotional responses, and provides the score to a user identification module that identifies users for online experiences.

In addition to (or alternatively in place of) determining a set of emotions for a user, module 404 can determine a set of emotions for a group of users. The determined emotions of the individual users in a group can be maintained along with the determined emotions of the group, or alternatively the determined emotions of the group can be maintained without maintaining the determined emotions of the individual users in that group. The emotions of a group can be determined based on the collected emotional response data in a variety of different manners. For example, the determined emotions of the members of the group can be used to determine the emotion of the group (e.g., if Boolean values for at least a threshold number of members of the group have been set to indicate happy, then the determined emotion of the group is happy, and otherwise the determined emotion of the group is not happy). By way of another example, the collected emotional response data can be used to determine emotions of the members of the group (e.g., the determined emotion of the group is happy if collectively the members of the group were detected as smiling and/or laughing for at least a threshold amount of time, and otherwise the determined emotion of the group is not happy). Groups of users can be defined in different manners, such as by a developer or vendor of system 400, by an online service using system 400, by users of system 400, and so forth. For example, groups can be defined as mother/daughter pairs, sibling pairs, foursomes, the individuals using a same computing device and/or in the same room at the same time, and so forth.

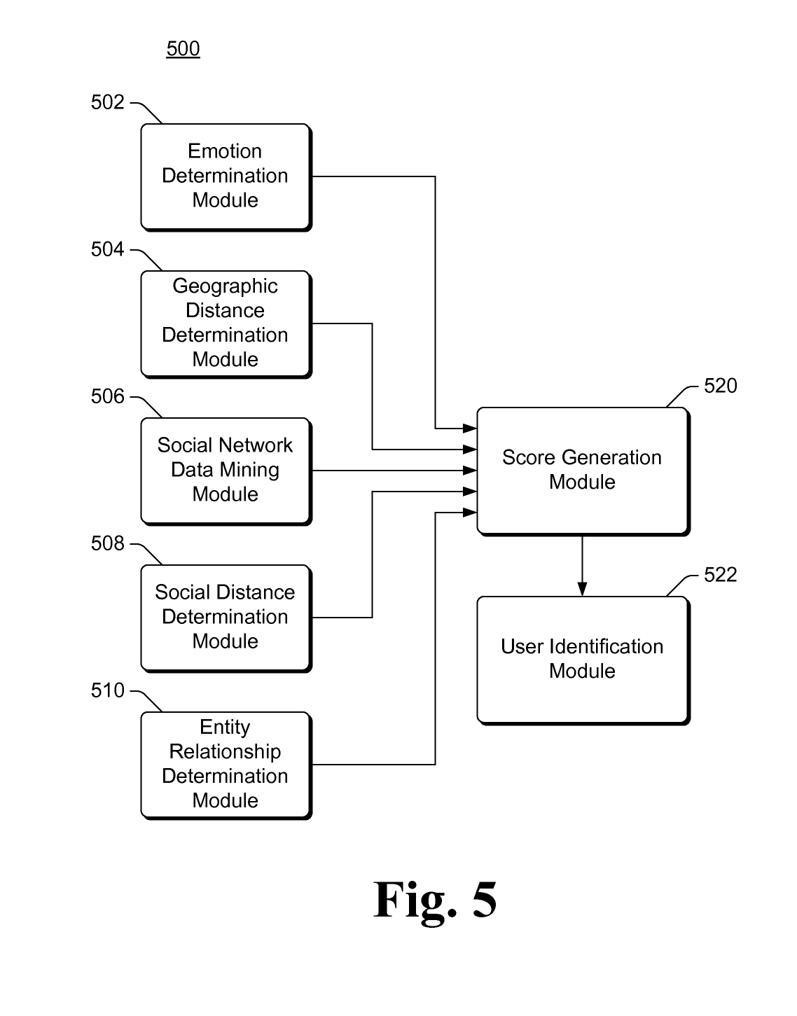

FIG. 5 illustrates another example emotion-based user identification system 500 in accordance with one or more embodiments. Emotion-based user identification system 500 can be, for example, an emotion-based user identification system 120 of FIG. 1 or an emotion-based user identification system 212 of FIG. 2. Emotion-based user identification system 500 can be implemented at least in part in an online service (e.g., online service 104 of FIG. 1) and/or at least in part in a computing device (e.g., one computing device 102 of FIG. 1 or computing device 202 of FIG. 2).

System 500 includes an emotion determination module 502, a geographic distance determination module 504, a social network data mining module 506, a social distance determination module 508, and an entity relationship determination module 510. An indication of a particular user of system 500 for which one or more users are to be identified to share an online experience with the particular user is provided to each of modules 502-510. This particular user for which one or more users are to be identified to share an online experience with is also referred to herein as the subject user. An indication of multiple other users from which the one or more users are to be selected is also provided to each of modules 502-510. These multiple other users can be identified in different manners, such as the subject user's friends, friends of the subject user's friends, users identified by the subject user, other users that are currently logged into the same online service as the subject user and that have expressed an interest in sharing a particular type of experience, and so forth.

Each module 502-510 generates a value, based on various factors, for the subject user with respect to each of multiple other users and provides those values to score generation module 520. The value generated by each module 502-510 for each of the multiple other users is based on both the particular other user and the subject user. Score generation module 520 combines the values to generate a score for each of the multiple other users, and provides the scores to user identification module 522, which identifies one or more of the multiple other users based on the scores.

Emotion determination module 502 determines an emotion of a user, as discussed above with reference to system 400 of FIG. 4, and provides a value to score generation module 520 representing the determined emotion. Emotion determination module 502 can be, for example, an emotion determination module 404 of FIG. 4.

Additionally, as discussed above, the determined emotions can be based on both the other user as well as the type of experience. Accordingly, emotion determination module 502 can provide multiple values for multiple different emotions to score generation module 520, and indicate which type of experience each such value corresponds to. Score generation module 520 can then generate a score based on the value from module 502 that corresponds to the type of experience for which user identification is being made by user identification module 522. Alternatively, the type of experience for which user identification is being made by user identification module 522 can be provided to emotion determination module 502, and module 502 can provide the value for the determined emotion for that type of experience to score generation module 520.

Geographic distance determination module 504 determines a geographic distance for a user, and provides a value to score generation module 520 indicating the geographic distance. The geographic distance for a user refers to a geographic distance between that user and the subject user. The geographic distance can be indicated in a variety of different manners, such as a numeric value indicating an approximate number of miles between the users. The locations of the devices being used by the users can be determined in different manners, such as determining latitude and longitude coordinates of the devices being used by the users (e.g., using global positioning system (GPS) components of the devices), determining zip codes in which the devices being used by the users are located (e.g., based on configuration settings of the devices or Internet service providers accessed by the devices), and so forth. Given the locations of the devices, an approximate or estimated number of miles between the users can be readily identified.

The geographic distance between the users can alternatively be indicated in other manners. For example, a value representing the geographic distance between the users can be generated based on whether the users are in the same city, state, country, etc., such as a value of 15 if the users are in the same city, a value of 10 if the users are in the same state but different cities, a value of 5 if the users are in the same country but different cities, and so forth. By way of another example, a value representing a range of geographic distances can be generated based on the locations of the users, such as a value of 15 if the users are within 20 miles of one another, a value of 10 if the users are between 20 and 100 miles away from one another, a value of 5 if the users are between 100 and 500 miles away from one another, and so forth.

Social network data mining module 506 obtains data from a social networking service (e.g., social networking service 114 of FIG. 1) and generates a value based on the similarity between data obtained from the social networking service for the subject user and the other user. Various data can be obtained from the social networking service, such as common interests listed by the users, movies or Web sites that the users have indicated they approve of or like, home towns of the users, school history of the users, information identified in photographs of the users (e.g., sports teams in photographs, cities in photographs, etc.), and so forth.

A value indicating a similarity between users can be generated based on the data obtained from the social networking service in a variety of different manners. For example, different values can be associated with each similarity identified in the data (e.g., a value associated with the users having the same home towns, a value associated with the users having common interests, etc.), and the values associated with each similarity added together. Alternatively, various other rules, criteria, algorithms, and so forth can be applied to generate a value indicating the similarity between users based on data obtained from the social networking service.

Social distance determination module 508 obtains data from a social networking service (e.g., social networking service 114 of FIG. 1) and generates a value indicating a social distance between the subject user and the other user. This social distance refers to the distance between the subject user and the other user in a social graph of the subject user. The social networking service maintains, for each user, a record of the friends of that user. Friends can take a variety of different forms, such as personal acquaintances, work acquaintances, family members, and so forth. The social distance between two users refers to the levels or steps of users between the two users. For example, the social distance can be a value of 30 if the other user is a friend of the subject user, can be a value of 15 if the other user is a friend of a friend of the subject user, can be a value of 7 if the other user is a friend of a friend of a friend of the subject user, and so forth.

Entity relationship determination module 510 obtains data from a social networking service (e.g., social networking service 114 of FIG. 1) and generates a value indicating a type of relationship that exists between the subject user and the other user. Different users can have different types of relationships, such as being personal acquaintances, work acquaintances, family members, and so forth. A value can be associated with each particular type of relationship, such as a value of 1 being associated with work acquaintances, a value of 5 being associated with family members, a value of 10 being associated with personal acquaintances, and so forth.

The values received from modules 502-510 for each of multiple other users can be combined by score generation module 520 in a variety of different manners. In one or more embodiments, the values from modules 502-510 can optionally be weighted to allow certain factors to more heavily influence the score generated by module 520 than other factors. The weights that are applied can be determined in different manners, such as based on empirical analysis performed by a developer or administrator of system 500, based on user inputs (e.g., a user of system 500 indicating the weights that he or she desires to have used), and so forth. For example, score generation module 520 can multiply each value output by a module 502-510 by the weight associated with that module 502-510 to generate a weighted value. It should be noted that weights can include positive numbers, negative numbers, integers, fractions, combinations thereof, and so forth. Module 520 can then add together or average (or alternatively perform one or more other mathematical functions on) the weighted values to generate the score.

The score generated by module 520 for a user is an indication of an expected amount of fun the subject user is likely to have, relative to other ones of the multiple users, when sharing an online experience with that user. For example, the subject user can be determined to be likely to have more fun when sharing an online experience with another user having a higher score (e.g., a score that is a larger number) than with another user having a lower score (e.g., a score that is a smaller number).

Score generation module 520 provides the scores for the multiple other users to user identification module 522, which identifies, based on the scores from module 520, one or more of the multiple other users to share an online experience with the subject user. This shared online experience can be a particular type of online experience, such as a particular game that the subject user desires to play, a particular movie that the subject user desires to watch, and so forth. User identification module 522 can identify ones of the multiple other users in different manners, such as identifying the user having the highest generated score, identifying multiple users having the highest generated scores (e.g., the ten highest scores or the highest 10% of the scores), identifying users having scores that meet (e.g., equal or exceed) a threshold value, and so forth.

Additionally, user identification module 522 can take various actions based on the identified users, such as automatically selecting an identified user (e.g., the one of the multiple other users having the highest score generated by module 520). Module 522 can provide an indication of the automatically selected user to another service for an online experience including the identified user and the subject user. For example, module 522 can provide an indication of the two users (the selected and subject users) to a game play service 112 of FIG. 1, which in turn establishes an online multi-player game including those two users. By way of another example, module 522 can provide an indication of the two users to an entertainment service 116 of FIG. 1, which in turn begins playing back a movie to those two users.

Alternatively, rather than automatically selecting another user, user identification module 522 can display or otherwise present identifiers of (e.g., user names, user id's or tags in the online system (e.g., online system 104 of FIG. 1), etc.) the identified users to the subject user. The scores generated for each of those identified users can optionally be presented to the subject user. The identified users can be, for example, the users having the highest scores generated by score generation module 520. The number of users that are identified can be determined in different manners, such as identifying users having the highest generated scores (e.g., the seven highest scores or the highest 10% of the scores), identifying users having generated scores that exceed a threshold value, and so forth. The subject user can then provide an input to choose at least one of those identified users. Indications of the chosen user (or chosen users) and the subject user are provided to another service for an online experience including the chosen user and the subject user (e.g., playing of a multi-player game, playback of a movie, etc.), optionally only if the chosen user (or chosen users) accepts an invitation or otherwise agree to being included in the shared online experience.

In one or more embodiments, the scores generated by module 520 are numeric values (e.g., ranging from 1-100) that can optionally be presented to the subject user by user identification module 522. Alternatively, the scores can be other values, such as Boolean values (e.g., indicating “fun” or “not fun”) that can optionally be presented to the subject user by user identification module 522.

Although system 500 includes multiple modules 502-510, it should be noted system 500 need not include (and/or need not use) all of the modules 502-510. For example, no geographic distance determination module 504 could be included in (or used by) system 500, in which case the geographic distance factor is not used by score generation module 520 in generating scores. Which factors are used by score generation module 520 can be determined in different manners, such as based on the desires of a developer or administrator of system 500, based on user inputs (e.g., a user of system 500 indicating which factors he or she desires to have used), and so forth.

In one or more embodiments, system 500 includes emotion determination module 502, but does not include (and/or does not use) modules 504-510. In such embodiments, scores are generated by score generation module 520 based on determined emotions but not on other factors. Furthermore, in such embodiments system 500 need not include score generation module 520. Rather, the indications of the determined emotions generated by module 502 can be provided to user identification module 522 and used analogous to the scores generated by module 520.

In some of the discussions above, reference is made to generating scores for each of multiple other users. It should be noted, however, that the emotion-based user identification for online experiences techniques discussed herein can be applied to any number of users. For example, an emotion can be determined for a subject user when he or she is interacting with a particular group of two or more other users (e.g., the subject user may laugh more when he or she is interacting with the group than with just one other user in that group). Emotional response data can be collected for groups of users analogous to the discussion above, and used to determine an emotion for that user and the group analogous to the discussion above. Scores can be generated (by score generation module 520) based on the groups of the multiple other users rather than individual ones of the multiple other users. Thus, for example, rather than being presented with a list of other users from which to choose, the subject user can be presented with a list of other users and/or groups of other users from which to choose.

Additionally, in some of the discussions above reference is made to determining an emotion for a subject user. It should be noted, however, that the emotion-based user identification for online experiences techniques discussed herein can be applied to any number of users. For example, an emotion can be determined for a group of users, which can be defined in a variety of different manners, as discussed above. This group then be referred to as the subject user, and scores can be generated (by score generation module 520) analogous to the discussion above except with the group of users being the subject user.

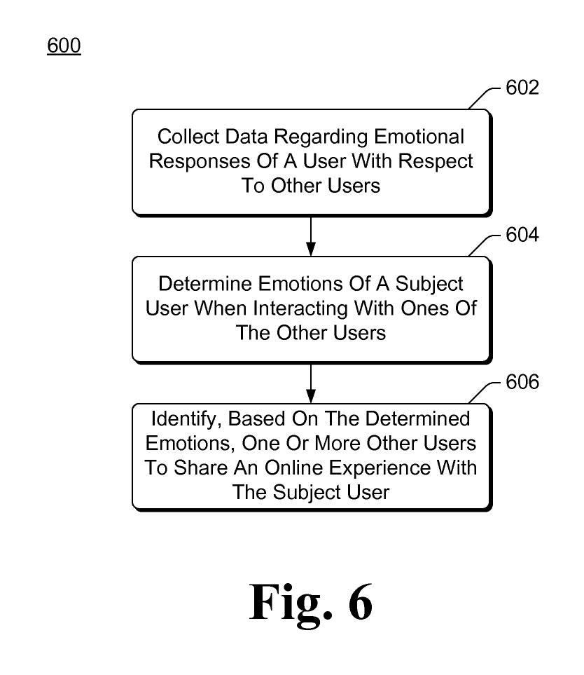

FIG. 6 is a flowchart illustrating an example process 600 for implementing emotion-based user identification for online experiences in accordance with one or more embodiments. Process 600 is carried out by a system, such as system 400 of FIG. 4 or system 500 of FIG. 5, and can be implemented in software, firmware, hardware, or combinations thereof. Process 600 is shown as a set of acts and is not limited to the order shown for performing the operations of the various acts. Process 600 is an example process for implementing emotion-based user identification for online experiences; additional discussions of implementing emotion-based user identification for online experiences are included herein with reference to different figures.

In process 600, data regarding emotional responses of a user with respect to other users is collected (act 602). Emotional responses of a user can be collected in a variety of different manners, such as facial feature detection, audio feature detection, data mining communications, and so forth as discussed above.

An emotion of a subject user when interacting with another user is determined (act 604). The collected emotional response data can be analyzed in a variety of different manners using various different rules, criteria, and/or algorithms to determine the emotion of the subject user as discussed above.

One or more other users with which the subject user can share an online experience with are identified based on the determined emotions (act 606). This identification can take different forms as discussed above, such as identifying ones of the other users having the highest scores. The identified one or more other users can be automatically selected to be included in a shared online experience with the subject user, or can be identified to the subject user so that the subject user can choose one or more of the identified users as discussed above.

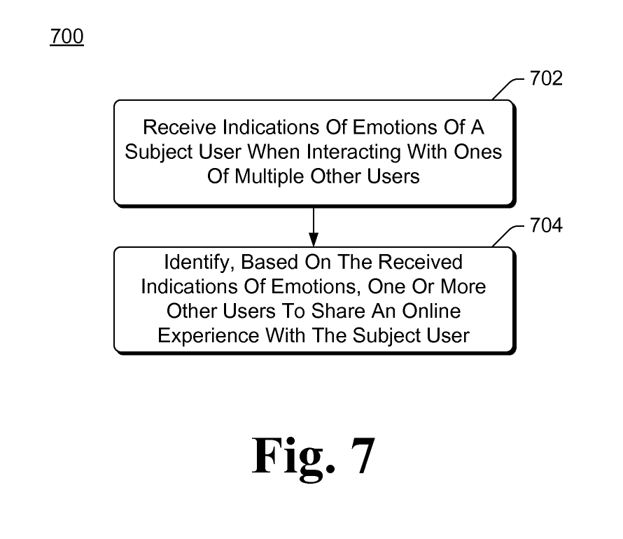

FIG. 7 is a flowchart illustrating another example process 700 for implementing emotion-based user identification for online experiences in accordance with one or more embodiments. Process 700 is carried out by a system, such as system 400 of FIG. 4 or system 500 of FIG. 5, and can be implemented in software, firmware, hardware, or combinations thereof. Process 700 is shown as a set of acts and is not limited to the order shown for performing the operations of the various acts. Process 700 is an example process for implementing emotion-based user identification for online experiences; additional discussions of implementing emotion-based user identification for online experiences are included herein with reference to different figures.

In process 700, indications of emotions of a user when interacting with ones of multiple other users are received (act 702). The indications of emotions can be determined in a variety of different manners using various different rules, criteria, and/or algorithms to determine the emotions of the subject user as discussed above. The indications of emotions can take various forms, such as a Boolean value indicating happy or not happy, a particular value from a set of possible values, a numeric value, and so forth as discussed above.

One or more other users with which the user can share an online experience with are identified based on the received indications of emotions (act 704). This identification can take different forms as discussed above, such as identifying ones of the other users having the highest scores. The identified one or more other users can be automatically selected to be included in a shared online experience with the subject user, or can be identified to the subject user so that the subject user can choose one or more of the identified users as discussed above.

The emotion-based user identification for online experiences techniques discussed herein support various usage scenarios. For example, an online game play service can receive a request from a particular user to play a particular game title. Various other users that particular user has previously interacted with in a positive manner (e.g., the particular user was frequently laughing or smiling) can be identified and presented to the particular user, from which the particular user can choose who he or she would like to play the game title with. Similarly, while additional users that particular user has previously interacted with in a negative manner (e.g., the particular user was not frequently laughing or smiling) would not be identified and presented to the particular user.

Various actions such as communicating, receiving, storing, generating, obtaining, and so forth performed by various modules are discussed herein. It should be noted that the various modules can cause such actions to be performed. A particular module causing an action to be performed includes that particular module itself performing the action, or alternatively that particular module invoking or otherwise accessing another component or module that performs the action (or performs the action in conjunction with that particular module).

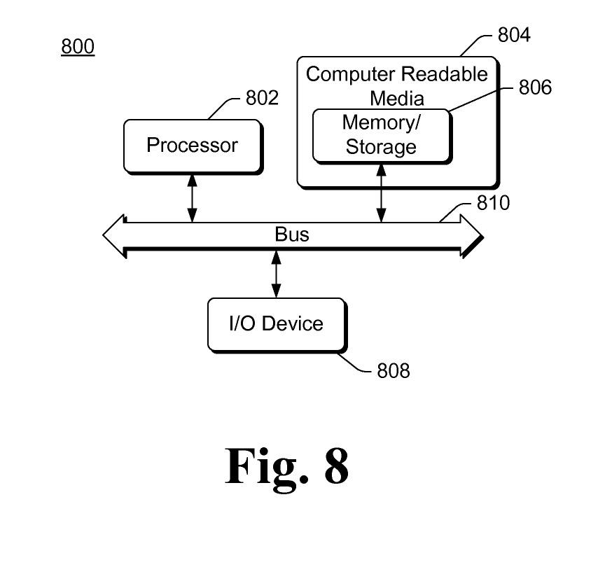

FIG. 8 illustrates an example computing device 800 that can be configured to implement the emotion-based user identification for online experiences in accordance with one or more embodiments. Computing device 800 can, for example, be a computing device 102 of FIG. 1, implement at least part of online service 104 of FIG. 1, be a computing device 202 of FIG. 2, implement at least part of system 400 of FIG. 4, or implement at least part of system 500 of FIG. 5.

Computing device 800 includes one or more processors or processing units 802, one or more computer readable media 804 which can include one or more memory and/or storage components 806, one or more input/output (I/O) devices 808, and a bus 810 that allows the various components and devices to communicate with one another. Computer readable media 804 and/or one or more I/O devices 808 can be included as part of, or alternatively may be coupled to, computing device 800. Bus 810 represents one or more of several types of bus structures, including a memory bus or memory controller, a peripheral bus, an accelerated graphics port, a processor or local bus, and so forth using a variety of different bus architectures. Bus 810 can include wired and/or wireless buses.

Memory/storage component 806 represents one or more computer storage media. Component 806 can include volatile media (such as random access memory (RAM)) and/or nonvolatile media (such as read only memory (ROM), Flash memory, optical disks, magnetic disks, and so forth). Component 806 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 802. It is to be appreciated that different instructions can be stored in different components of computing device 800, such as in a processing unit 802, in various cache memories of a processing unit 802, in other cache memories of device 800 (not shown), on other computer readable media, and so forth. Additionally, it is to be appreciated that the location where instructions are stored in computing device 800 can change over time.

One or more input/output devices 808 allow a user to enter commands and information to computing device 800, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, applications, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 8. The features of the emotion-based user identification for online experiences, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
determining, for each of multiple other users, an emotion of a first user when interacting with the other user; and
identifying, based at least in part on the determined emotions, one or more of the multiple other users to share an online experience with the first user.

2. A method as recited in claim 1, further comprising:
generating, based on the determined emotions, a score for each of the multiple other users; and
presenting identifiers of one or more of the multiple other users having the highest scores.

3. A method as recited in claim 1, the determining comprising determining the emotion of the first user based on emotional responses of the first user during interaction of the first user with the other user during another online experience with the other user.

4. A method as recited in claim 1, the determining comprising determining the emotion of the first user based on emotional responses of the first user during interaction of the first user with the other user during an in-person experience with the other user.

5. A method as recited in claim 1, the determining comprising determining the emotion of the first user based on data indicating emotional responses of the first user in communications between the first user and the other user.

6. A method as recited in claim 1, the determining comprising determining, for each of multiple types of experiences with each of multiple other users, an emotion of the first user when interacting with the other user with the type of experience, the identifying comprising identifying, based on the determined emotions for a particular type of experience, one or more of the multiple other users to share an online experience of the particular type of experience with the first user.

7. A method as recited in claim 6, the particular type of experience comprising a particular game title.

8. A method as recited in claim 1, the online experience comprising a multi-player online game.

9. A method as recited in claim 1, the identifying further comprising identifying the one or more of the multiple other users based at least in part on a geographic distance between the first user and each of the multiple other users.

10. A method as recited in claim 1, the identifying further comprising identifying the one or more of the multiple other users based at least in part on data regarding the first user and the multiple other users from a social networking service.

11. A method as recited in claim 1, the identifying further comprising identifying the one or more of the multiple other users based at least in part on a social distance between the first user and each of the multiple other users.

12. A method as recited in claim 1, the identifying further comprising identifying the one or more of the multiple other users based at least in part on common entities between the first user and each of the multiple other users in a social networking service.

13. One or more computer storage media having stored thereon multiple instructions that, when executed by one or more processors, cause the one or more processors to:
receive, for a user, indications of emotions of the user when interacting with each of multiple other users; and
identify, based at least in part on the received indications of emotions of the user, one or more of the other users to share an online experience with the user.

14. One or more computer storage media as recited in claim 13, the indications of emotions of the user comprising indications of emotions of the user when interacting with each of the multiple other users for each of multiple types of experiences, the instructions that cause the one or more processors to identify the one or more of the other users comprising instructions that cause the one or more processors to identify, based on the received indications of emotions for a particular type of the multiple types of experiences, one or more of the other users to share an online experience of the particular type of experience with the user.

15. One or more computer storage media as recited in claim 14, the particular type of experience comprising a particular game title.

16. One or more computer storage media as recited in claim 13, the multiple instructions further causing the one or more processors to:
generate, based on the received indications of emotions, a score for each of the multiple other users; and
present, for choosing by the user, identifiers of one or more of the multiple other users having the highest scores.

17. One or more computer storage media as recited in claim 13, the interacting comprising messages communicated between the user and the other user.

18. One or more computer storage media as recited in claim 13, the interacting comprising interacting with the other user during an online experience with the other user.

19. One or more computer storage media as recited in claim 13, the interacting comprising interacting with the other user when during an in-person experience with the other user.

20. A method comprising:
collecting, for each of multiple other users and each of multiple game titles, data regarding emotional responses of a first user when playing the game title with the other user;
determining, for each of the multiple other users and each of the multiple game titles, an emotion of the first user when playing the game title with the other user; and
identifying, based at least in part on the determined emotions, one or more of the multiple other users to play one of the multiple game titles with the first user.
